(19) United States
(12) Patent Application Publication
(10) Pub. No.: US 2008/0116162 A1
(43) Pub. Date: May 22, 2008

(54) Container with tamper evident band

(76) Inventor: Michael E. Penny, Saline, MI (US)

Correspondence Address: HARNESS, DICKEY & PIERCE, P.L.C., P.O. BOX 828, BLOOMFIELD HILLS, MI, 48303, US

(21) Appl. No.: 11/601,863

(22) Filed: Nov. 17, 2006

(51) Int. Cl. B65D 23/00; B29C 49/00; B65D 1/02; B65D 1/10

(52) U.S. Cl. 215/44; 264/524

(57) ABSTRACT

A container and a method of making a container are provided. In one example, the container includes a body having an upper portion, a sidewall portion and a base portion. The upper portion includes a blown finish defining a longitudinal axis and an opening into the container. A first portion defines a tamper evident (TE) band formed on the finish and defines a first diameter at an outermost surface. A second portion is formed on the finish, offset toward the base portion relative to the first portion, and defines a second diameter. The second diameter is less than the first diameter. A transition portion is formed between the first and second portions. The transition portion defines an annular taper from the first portion to the second portion.

### TECHNICAL FIELD

This disclosure generally relates to containers for retaining a commodity, such as a solid or liquid commodity. More specifically, this disclosure relates to a blown polyethylene terephthalate (PET) container having a blown container finish including a threaded area and a tamper evident (TE) band area.

### BACKGROUND

As a result of environmental and other concerns, plastic containers, more specifically polyester and even more specifically polyethylene terephthalate (PET) containers are now being used more than ever to package numerous commodities previously supplied in glass containers. Manufacturers and fillers, as well as consumers, have recognized that PET containers are lightweight, inexpensive, recyclable and manufacturable in large quantities.

Blow-molded plastic containers have become commonplace in packaging numerous commodities. PET is a crystallizable polymer, meaning that it is available in an amorphous form or a semi-crystalline form. The ability of a PET container to maintain its material integrity relates to the percentage of the PET container in crystalline form, also known as the “crystallinity” of the PET container. The following equation defines the percentage of crystallinity as a volume fraction:

$$\% Crystallinity = ( \frac{ρ - {ρ}_{a}}{{ρ}_{c} - {ρ}_{a}} ) \times 100$$

where ρ is the density of the PET material; ρₐ is the density of pure amorphous PET material (1.333 g/cc); and ρ_{c} is the density of pure crystalline material (1.455 g/cc).

Container manufacturers use mechanical processing and thermal processing to increase the PET polymer crystallinity of a container. Mechanical processing involves orienting the amorphous material to achieve strain hardening. This processing commonly involves stretching an injection molded PET preform along a longitudinal axis and expanding the PET preform along a transverse or radial axis to form a PET container. The combination promotes what manufacturers define as biaxial orientation of the molecular structure in the container. Manufacturers of PET containers currently use mechanical processing to produce PET containers having approximately 20% crystallinity in the container's sidewall.

Thermal processing involves heating the material (either amorphous or semi-crystalline) to promote crystal growth. On amorphous material, thermal processing of PET material results in a spherulitic morphology that interferes with the transmission of light. In other words, the resulting crystalline material is opaque, and thus, generally undesirable. Used after mechanical processing, however, thermal processing results in higher crystallinity and excellent clarity for those portions of the container having biaxial molecular orientation. The thermal processing of an oriented PET container, which is known as heat setting, typically includes blow molding a PET preform against a mold heated to a temperature of approximately 250° F.-350° F. (approximately 121° C.-177° C.), and holding the blown container against the heated mold for approximately two (2) to five (5) seconds. Manufacturers of PET juice bottles, which must be hot-filled at approximately 185° F. (85° C.), currently use heat setting to produce PET bottles having an overall crystallinity in the range of approximately 25%-35%.

In many applications, it is desirable to provide a closure or cap for mating with a finish of the bottle or container. Many such bottle and cap combinations are designed with a Tamper Evident (TE) breakaway band on the cap. Such a band is attached to the cap when initially applied to the corresponding bottle finish and upon opening the bottle for the first time, the band is designed to break away from the cap and remain on the bottle. Since the band can only break away one time, the resulting effect proves whether or not a bottle has been tampered with, or more specifically, if the cap has been removed prior to the actual customer opening the bottle.

With reference to FIG. 1, a finish and cap according to prior art is shown. In the finish of a container, the TE band profile includes two diameters which the standardized Packaging Industry identifies as A₁ (A-diameter) and B₁ (B-diameter), respectively on FIG. 1. The B-diameter is typically smaller while the A-diameter is typically larger. The larger A-diameter represents a bulge in the container finish profile that is designed as a catch to stop and prevent the TE band of the cap from riding over the top of it in a reverse direction when the cap is removed from the container. The TE band of the cap is designed to ride over the A-diameter band profile of the container in a forward (downward) direction when the cap is initially applied to the container. The prevention of the band moving back up on the bottle when the cap is removed thus creates the necessary engagement interface and force that effectively removes the breakaway band from the cap and hence leaves it on the container finish.

Within the realms of the PET blow molding industry, where it is desirable to convert injection molded PET performs into blow molded PET containers, it has been shown that any blow moldable detail that is designed and built into any given blow mold, be sized in such a way that ensures duplication of that mold detail onto the moldable surface of the given container. The inherent nature of PET causes the molded container to become stiffer as it biaxially orientates. As a result, it is important to define any embossed detail as having a height dimension (i.e. in a direction along the axis of the container) to be sufficiently greater than a depth dimension (i.e. in a direction generally transverse to the axis of the container).

### SUMMARY

Accordingly, the present disclosure provides a container and a method of making a container. In one example, the container includes a body having an upper portion, a sidewall portion and a base portion. The upper portion includes a blown finish defining a longitudinal axis and an opening into the container. A first portion defines a tamper evident (TE) band formed on the finish and defines a first diameter at an outermost surface. A second portion is formed on the finish, offset toward the base portion relative to the first portion and defines a second diameter. The second diameter is less than the first diameter. A transition portion is formed between the first and second portions. The transition portion defines an annular taper from the first portion to the second portion.

According to additional features, a third portion is formed on the finish and offset away from the base portion relative to the first portion and defines a third diameter. A difference between the first diameter and the third diameter defines a TE band depth. A height defined along the longitudinal axis between the second portion and the third portion defines a TE band height. The TE band height is substantially about three times the TE band depth. The first portion defines a first height along the longitudinal axis. The transition portion defines a transition height along the longitudinal axis. The first height and the transition height collectively define the TE band height. The transition height is at least 25% of the TE band height.

Additional benefits and advantages of the present disclosure will become apparent to those skilled in the art to which the present disclosure relates from the subsequent description and the appended claims, taken in conjunction with the accompanying drawings.

### BRIEF DESCRIPTION OF THE DRAWINGS

FIG. 1 is a sectional view of a finish of a container and associated cap according to prior art.

FIG. 2 is a side elevational view of a container constructed in accordance with the teachings of the present disclosure shown with an exemplary cap having a breakaway band attached to the cap prior to initial capping onto the container.

FIG. 3 is a sectional view taken along line 3-3 through a finish of the container of FIG. 2 shown with the cap in an initially capped position.

FIG. 4 is a sectional view of the finish of the container of FIG. 3 shown with the breakaway band broken away from the cap subsequent to initial uncapping.

FIG. 5 is a sectional view of an exemplary mold cavity used during formation of the container of FIG. 2 and shown with a preform positioned therein; and

FIG. 6 is a side elevational view of an intermediate container formed by the mold cavity of FIG. 5.

### DETAILED DESCRIPTION

The following description is merely exemplary in nature, and is in no way intended to limit the disclosure or its application or uses.

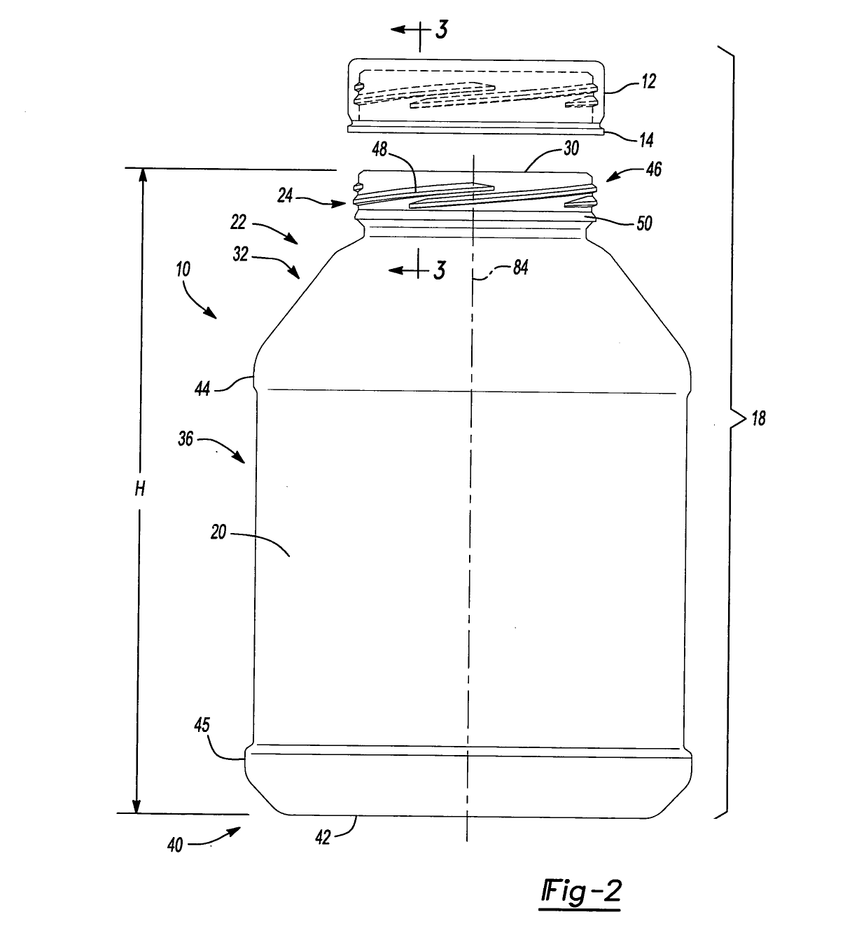

FIG. 2 shows one preferred embodiment of the present container. In the Figures, reference number 10 designates a one-piece plastic, e.g. polyethylene terephthalate (PET), hot-fillable container. The container 10 is shown with an exemplary cap 12. The cap 12 includes a breakaway band 14. The container 10 and cap 12 are collectively referred to herein as a bottle assembly 18. As shown in FIG. 2, the container 10 has an overall height H of about 177.10 mm (6.97 inch). The container 10 may be substantially cylindrical in cross section. In this particular embodiment, the container 10 has a volume capacity of about 32 fl. oz. (946 cc). Those of ordinary skill in the art would appreciate that the following teachings are applicable to other containers, such as rectangular, triangular, hexagonal, octagonal or square shaped containers, which may have different dimensions and volume capacities. It is also contemplated that other modifications can be made depending on the specific application and environmental requirements.

The container 10 according to the present teachings defines a body 20 and includes an upper portion 22 having a finish 24. The finish 24 defines an opening 30 into the container 10. Integrally formed with the finish 24 and extending downward therefrom is a shoulder region 32. The shoulder region 32 merges into and provides a transition between the finish 24 and a sidewall portion 36. The sidewall portion 36 extends downward from the shoulder region 32 to a base portion 40 having a base 42. An upper bumper portion 44 may be defined at a transition between the shoulder region 32 and the sidewall portion 36. A lower bumper portion 45 may be defined at a transition between the base portion 40 and the sidewall portion 36.

Those skilled in the art know and understand that a neck (not illustrated) may also be included having an extremely short height, that is, becoming a short extension from the finish 24, or an elongated height, extending between the finish 24 and the shoulder region 32. The container 10 has been designed to retain a commodity. The commodity may be in any form such as a solid or liquid product. In one example, a liquid commodity may be introduced into the container 10 during a thermal process, typically a hot-fill process. For hot-fill bottling applications, bottlers generally fill the container 10 with a liquid or product at an elevated temperature between approximately 155° F. to 205° F. (approximately 68° C. to 96° C.) and seal the container 10 with the cap 12 before cooling. In addition, the container 10 may be suitable for other high-temperature pasteurization or retort filling processes or other thermal processes as well. In another example, the commodity may be introduced into the container 10 under ambient temperatures.

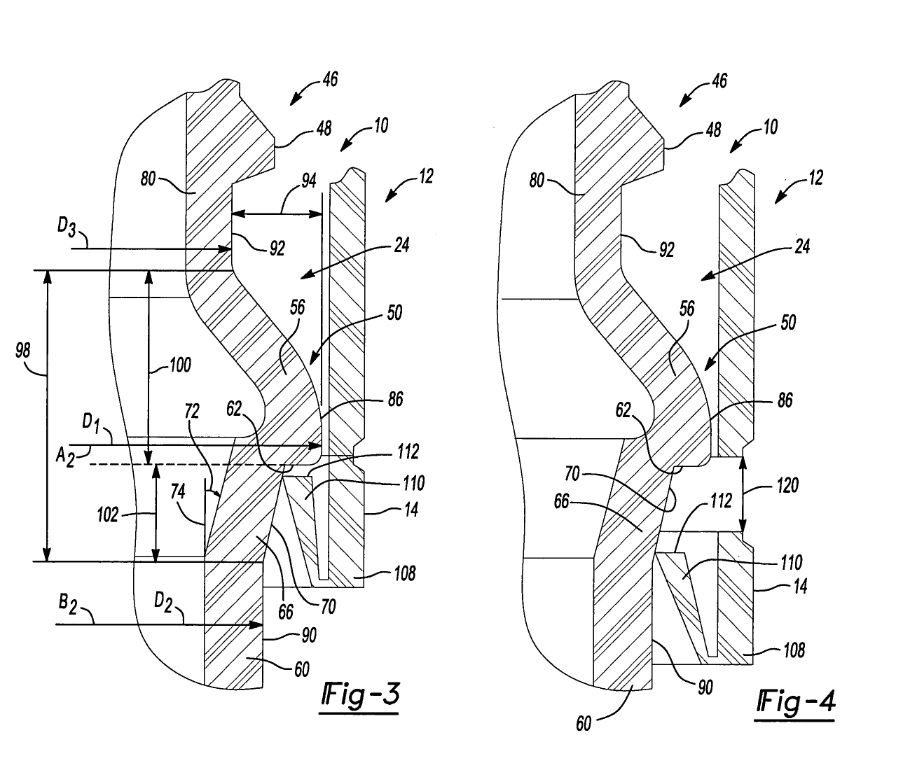

With continued reference to FIG. 2 and further reference to FIG. 3, the finish 24 will be described in greater detail. The finish 24 of the container 10 generally includes a threaded region 46 having threads 48 and a tamper evident (TE) band 50. While not shown, the finish 24 may also include a support ring. Explained in more detail, a first portion 56 defines the TE band 50, a second portion 60 is formed on the finish 24 and offset toward the base portion 40 (FIG. 2). The TE band 50 defines a downwardly facing annular lip 62. A transition portion 66 is formed between the first and second portions 56 and 60, respectively. The transition portion 66 generally defines an annular taper surface 70 from the first portion 56 to the second portion 60. The transition portion 66 defines an angle of divergence 72 from a vertical plane 74 of greater than 0 degrees and less than 90 degrees. According to the example shown, the angle of divergence 72 is approximately 3 degrees to approximately 10 degrees, and preferably 5 degrees. A third portion 80 is formed on the finish 24 and offset away from the base portion 40 (FIG. 2) relative to the first portion 56. The finish 24 also defines a longitudinal axis 84 (FIG. 2).

Exemplary dimensions for the finish 24 will be described. It is appreciated that other dimensions may be used. A diameter D₁ is defined at an outermost surface 86 of the TE band 50 (also identified as A-diameter, A₂). A diameter D₂ is defined at an outer surface 90 of the second portion 60 (also identified as B-diameter, B₂). A diameter D₃ is defined at an outer surface 92 of the third portion 80. A TE band depth 94 is defined laterally between the outermost surface 86 of the TE band 50 and the outer surface 92 of the third portion 80. A TE band height 98 is defined along the longitudinal axis 84 of the finish 24 between the second portion 60 and the third portion 80. In this way, the TE band height 98 is defined collectively by a first portion height 100 and a transition portion height 102. The transition portion height 102 is at least 25% of the TE band height 98. An aspect ratio is defined between the TE band height 98 relative to the TE band depth 94. According to the present teachings, the blow-molded PET finish provides an aspect ratio in the range of approximately 2.5:1 to 4:1, and preferably 3:1.

The threaded region 46 provides a means for attachment of a similarly threaded closure or cap, such as the cap 12. Alternatives may include other suitable devices that engage the finish 24 of the container 10. Accordingly, the closure or cap engages the finish 20 to preferably provide a hermetical seal of the container 10.

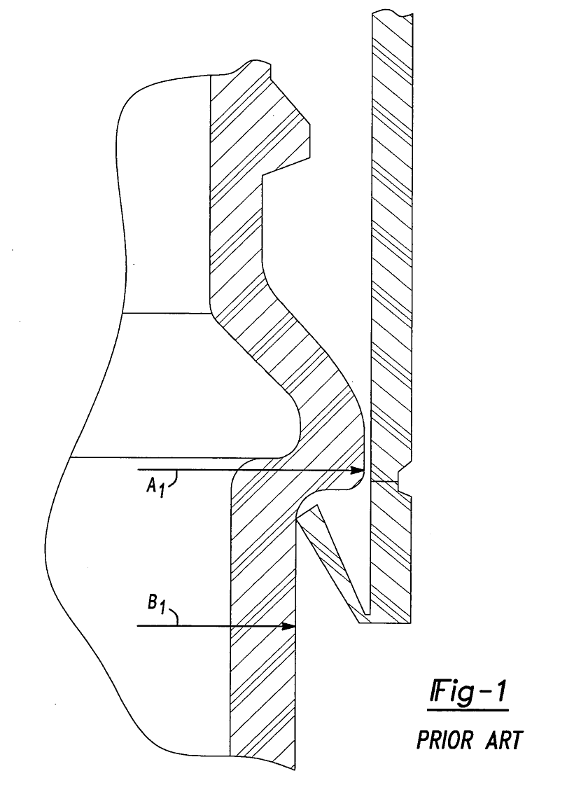

With continued reference to FIG. 3, the cap 12 will be described in greater detail. The cap 12 is preferably formed of a plastic or metal material conventional to the closure industry and suitable for subsequent thermal processing, including high temperature pasteurization and retort. The breakaway band 14 is shown coupled to the cap 12 in the initially capped position. As is known in the art, the breakaway band 14 is adapted to break away from the cap 12 and thus remain on the container 10. In the example shown, the breakaway band 14, subsequent to being broken away, is adapted to rest at the upper portion 22 of the container 10 such as at the shoulder portion 32. It is appreciated that a support ring (not shown) may also be provided for receiving the breakaway band 14. Since the breakaway band 14 only breaks away one time (i.e. as a result of the first uncapping), the resulting effect proves whether or not a container has been tampered with or more specifically if the cap has been removed prior to an actual consumer's opening of the container. The breakaway band 14 is further defined by a band body 108 and a flap 110 extending therefrom. The flap 110 extends generally inboard of the band body 108. The flap 110 defines a terminal end surface 112. As is shown in FIG. 3, the flap 110 engages the taper surface 70 of the transition portion 66. In this way, the terminal end surface 112 of the flap 110 extends generally parallel to the downwardly facing annular lip 62 of the TE band 50. As can be appreciated, the parallel relationship improves quick and efficient break of the breakaway band 14 from the cap 12 versus a terminal end surface extending at an angle relative to a downwardly facing annular lip of a TE band (see e.g., FIG. 1, Prior Art).

Turning now to FIG. 4, the breakaway band 14 is shown broken from the cap 12 subsequent to initial uncapping. Notably, the breakaway band 14 occupies a position offset from the cap 12 defining a gap 120. According to the present teachings, the taper surface 70 of the transition portion 60 urges the breakaway band 14 in a downward direction (i.e. away from the TE band 50) subsequent to initial uncapping. The gap 120 is a strong visual aid to a consumer in that it helps identify whether or not a container has been opened or tampered with prior to initial opening of the container by the end user.

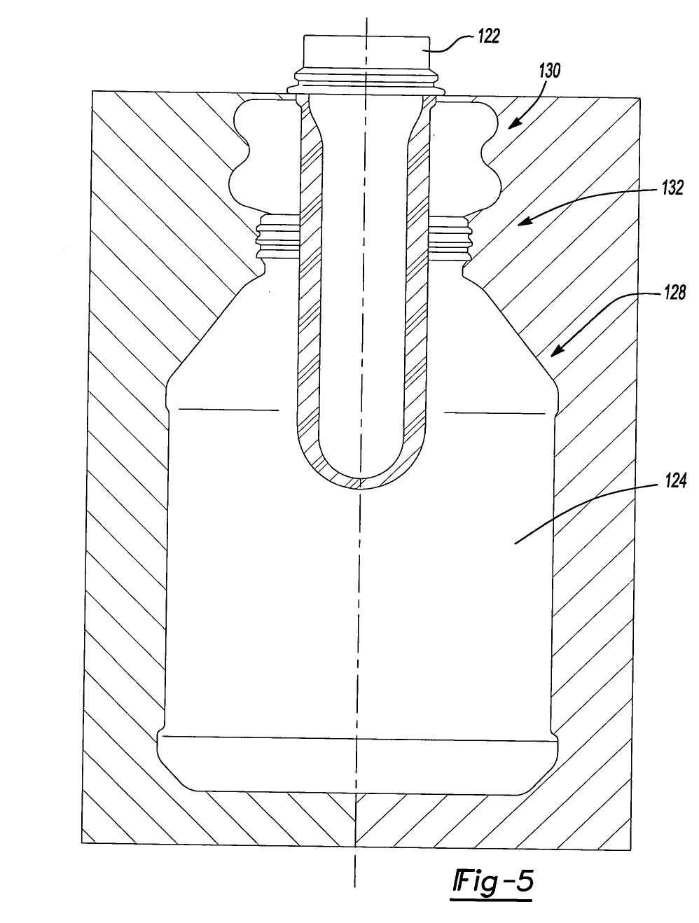

The container 10 of the present invention is a blow molded, biaxially oriented container with a unitary construction from a single or multi-layer material. A well-known stretch-molding, heat-setting process for making the container 10 generally involves the manufacture of a preform 122 (FIG. 5) of a polyester material, such as polyethylene terephthalate (PET), having a shape well known to those skilled in the art similar to a test-tube with a generally cylindrical cross section and a length typically approximately fifty percent (50%) that of the container height. An exemplary method of manufacturing the container 10 will be described in greater detail later.

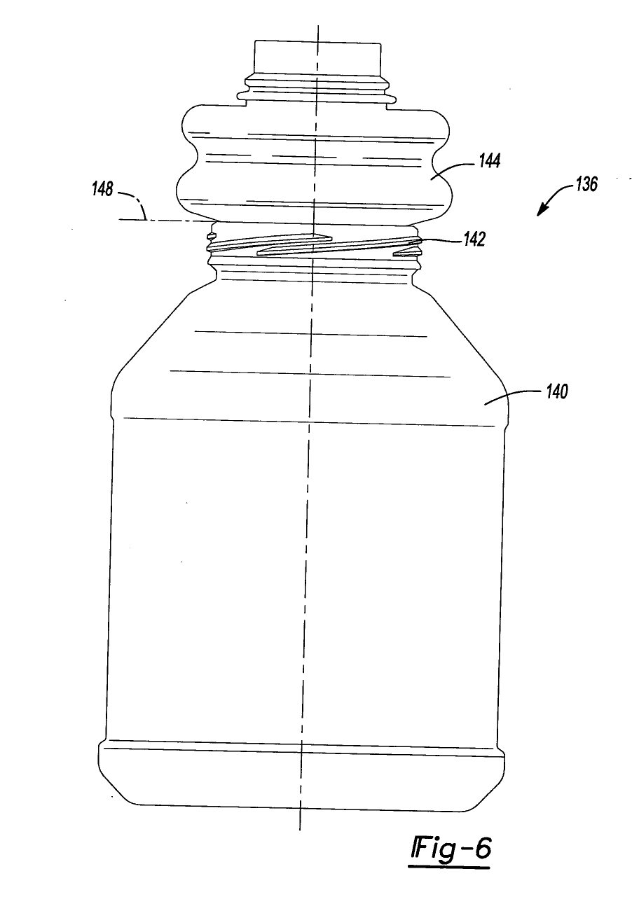

Turning now to FIG. 6, an exemplary method of forming the container 10 will be described. At the outset, the preform 122 may be placed into a mold cavity 124. In general, the mold cavity 124 has an interior surface corresponding to a desired outer profile of the blown container. More specifically, the mold cavity 124 according to the present teachings defines a body-forming region 128, a finish forming region 132 and a moil-forming region 130. The resultant structure, hereinafter referred to as an intermediate container 136, as illustrated in FIG. 6, generally includes a body 140, a finish 142 and a moil 144.

In one example, a machine (not illustrated) places the preform 122 heated to a temperature between approximately 190° F. to 250° F. (approximately 88° C. to 121° C.) into the mold cavity 124. The mold cavity 124 may be heated to a temperature between approximately 250° F. to 350° F. (approximately 121° C. to 177° C.). A stretch rod apparatus (not illustrated) stretches or extends the heated preform 122 within the mold cavity 124 to a length approximately that of the intermediate container 136 thereby molecularly orienting the polyester material in an axial direction generally corresponding with the central longitudinal axis 84 of the container 10. While the stretch rod extends the perform 122, air having a pressure between 300 PSI to 600 PSI (2.07 MPa to 4.14 MPa) assists in extending the preform 122 in the axial direction and in expanding the preform 122 in a circumferential or hoop direction thereby substantially conforming the polyester material to the shape of the mold cavity 124 and further molecularly orienting the polyester material in a direction generally perpendicular to the axial direction, thus establishing the biaxial molecular orientation of the polyester material in most of the intermediate container 136. The pressurized air holds the mostly biaxial molecularly oriented polyester material against the mold cavity 124 for a period of approximately two (2) to five (5) seconds before removal of the intermediate container 136 from the mold cavity 124.

In another example, a machine (not illustrated) places the preform 122 heated to a temperature between approximately 185° F. to 239° F. (approximately 85° C. to 115° C.) into the mold cavity 124. The mold cavity 124 may be chilled to a temperature between approximately 32° F. to 75° F. (approximately 0° C. to 24° C.). A stretch rod apparatus (not illustrated) stretches or extends the heated preform 122 within the mold cavity 124 to a length approximately that of the intermediate container thereby molecularly orienting the polyester material in an axial direction generally corresponding with the central longitudinal axis 84 of the container 10. While the stretch rod extends the preform 122, air having a pressure between 300 PSI to 600 PSI (2.07 MPa to 4.14 MPa) assists in extending the preform 122 in the axial direction and in expanding the preform 122 in a circumferential or hoop direction thereby substantially conforming the polyester material to the shape of the mold cavity 124 and further molecularly orienting the polyester material in a direction generally perpendicular to the axial direction, thus establishing the biaxial molecular orientation of the polyester material in most of the intermediate container. The pressurized air holds the mostly biaxial molecularly oriented polyester material against the mold cavity 124 for a period of approximately two (2) to five (5) seconds before removal of the intermediate container from the mold cavity 124. This process is utilized to produce containers suitable for filling with product under ambient conditions or cold temperatures.

Alternatively, other manufacturing methods using other conventional materials including, for example, polyethylene naphthalate (PEN), a PET/PEN blend or copolymer, and various multilayer structures may be suitable for the manufacture of container 10. Those having ordinary skill in the art will readily know and understand container manufacturing method alternatives.

Once the intermediate container 136 has been formed, the intermediate container 136 may be removed from the mold cavity 124. As can be appreciated, the intermediate container 136 defines the container 10 (FIG. 2) and the moil 144 prior to formation of the opening 30 (FIG. 2). An intersection between the finish 142 and the moil 144 defines a cutting plane 148 (FIG. 6). The moil 144 is subsequently severed from the finish 142 at the cutting plane 148. The severing process may be any suitable cutting procedure that removes the moil 144 and creates the opening 30.

While the above description constitutes the present disclosure, it will be appreciated that the disclosure is susceptible to modification, variation and change without departing from the proper scope and fair meaning of the accompanying claims.

What is claimed is:

1. A plastic container comprising:
a body having an upper portion, a sidewall portion and a base portion, said upper portion including a blown finish defining a longitudinal axis and an opening into the container;
a first portion defining a tamper evident (TE) band formed on said finish and defining a first diameter at an outermost surface;
a second portion formed on said finish, offset toward said base portion relative to said first portion and defining a second diameter, said second diameter being less than said first diameter; and
a transition portion formed between said first and second portions, said transition portion defining an annular taper from said first portion to said second portion.

2. The plastic container of claim 1, further comprising a third portion formed on said finish, offset away from said base portion relative to said first portion and defining a third diameter.

3. The plastic container of claim 2 wherein a difference between said first diameter and said third diameter defines a TE band depth and wherein a height defined along said longitudinal axis between said second portion and said third portion defines a TE band height, wherein said TE band height is substantially about three times said TE band depth.

4. The plastic container of claim 3 wherein said first portion defines a first height along said longitudinal axis and said transition portion defines a transition height along said longitudinal axis, wherein said first height and said transition height collectively define said TE band height and wherein said transition height is at least 25% of said TE band height.

5. The plastic container of claim 4, further comprising a cap movable between a capped position and an uncapped position relative to said finish said cap having a breakaway portion including a flap extending radially inboard from said breakaway portion.

6. The plastic container of claim 5 wherein said flap defines a terminal end surface adapted to engage said TE band during withdrawal of said cap from said container, said terminal end surface extending substantially transverse to said longitudinal axis in said capped position.

7. The plastic container of claim 5 wherein said breakaway portion is adapted to breakaway from said cap during movement of said cap toward said uncapped position, wherein said transition portion urges said breakaway portion toward said base portion.

8. The plastic container of claim 5 wherein said first portion defines an annular lip surface, wherein said terminal end surface of said cap is offset substantially parallel from said annular ledge surface in said capped position.

9. The plastic container of claim 1 wherein said finish is a polyethylene terephthalate (PET) blown finish.

10. The plastic container of claim 1 wherein said annular taper defines an angle of approximately between 3 and 10 degrees relative to said longitudinal axis.

11. A plastic container comprising:
a body having an upper portion, a sidewall portion and a base portion, said upper portion including a blown finish defining a longitudinal axis and an opening into the container;
a first portion defining a tamper evident (TE) band formed on said finish and defining a first diameter at an outermost surface;
a second portion formed on said finish, offset toward said base portion relative to said first portion and defining a second diameter, said second diameter being less than said first diameter; and
a third portion formed on said finish, offset away from said base portion relative to said first portion and defining a third diameter at an outboard surface;
wherein a TE depth is defined in a transverse direction relative to said longitudinal axis between said outermost surface and said outboard surface and wherein a TE height is defined along said longitudinal axis between said second portion and said third portion, said TE height being in a range of about 2.5 times to about 4 times said TE depth.

12. The plastic container of claim 11 wherein said first portion defines a first height along said longitudinal axis and said transition portion defines a transition height along said longitudinal axis, wherein said first height and said transition height collectively define said TE band height and wherein said transition height is at least 25% of said TE band height.

13. The plastic container of claim 11, further comprising a cap movable between a capped position and an uncapped position relative to said finish said cap having a breakaway portion including a flap extending radially inboard from said breakaway portion.

14. The plastic container of claim 13 wherein said flap defines a terminal end surface adapted to engage said TE band during withdrawal of said cap from said container, said terminal end surface extending substantially transverse to said longitudinal axis in said capped position.

15. The plastic container of claim 13 wherein said breakaway portion is adapted to breakaway from said cap during movement of said cap toward said uncapped position, wherein said transition portion urges said breakaway portion toward said base portion.

16. The plastic container of claim 13 wherein said first portion defines an annular ledge surface, wherein said terminal end surface of said cap is offset substantially parallel from said annular ledge surface in said capped position.

17. The plastic container of claim 11 wherein said finish is a polyethylene terephthalate (PET) blown finish.

18. The plastic container of claim 11 wherein said TE height is substantially about 3 times said TE depth.

19. A method of making a blow-molded plastic container comprising:
disposing a preform into a mold cavity having a mold surface defining a body forming region and a finish forming region; and
blowing the preform against the mold surface to form a body defining a longitudinal axis and a finish at the finish forming region, the finish having a first portion defining a tamper evident (TE) band defining a first diameter at an outermost surface, a second portion offset toward the base portion relative to the first portion and defining a second diameter, the second diameter being less than the first diameter, and a transition portion formed between the first and second portions, the transition portion defining an annular taper from the first portion to the second portion.

20. The method of claim 19 wherein blowing the preform further includes forming a third region on the finish, offset away from the base portion relative to the first portion and defining a third diameter.

21. The method of claim 20 wherein blowing the preform further includes forming the TE band having a depth defined by a difference between the first and third diameters and a height defined along the longitudinal axis between the second portion and the third portion, wherein the height is in a range of about 2.5 times to about 4 times the depth.

22. The method of claim 21 wherein the height is in the range of about 3 times to depth.
